(19) United States
(12) Patent Application Publication
(10) Pub. No.: US 2020/0241232 A1
(43) Pub. Date: Jul. 30, 2020

(54) METHOD FOR ENCAPSULATING HYDROPHOBIC MATERIALS IN STABILIZED YEAST CELLS SUITABLE FOR PROCESSING WITH POLYMERS

(71) Applicant: CORNING INCORPORATED, Corning, NY (US)

(72) Inventor: Linda Sue Baker, Addison, NY (US)

(21) Appl. No.: 16/846,529

(22) Filed: Apr. 13, 2020

Related U.S. Application Data
(63) Continuation of application No. PCT/US2018/055146, filed on Oct. 10, 2018.
(60) Provisional application No. 62/571,950, filed on Oct. 13, 2017.

(51) Int. Cl. G02B 6/44; H01B 7/18; H01B 13/00; C08K 9/10

(52) U.S. Cl. CPC G02B 6/4494; C08K 9/10; H01B 13/0036; H01B 7/18

(57) ABSTRACT

Embodiments of a polymer composition that are configured for repelling animals are provided. The polymer composition includes at least one polymer, and a plurality of aversive additive particles dispersed in the at least one polymer. Each aversive additive particle is made up of an encapsulant, an aversive material contained within the encapsulant, and a protective material deposited around the encapsulant. The polymer composition can be used as a polymer jacket for a cable, such as an optical fiber cable, to keep animals from damaging the cable.

### PRIORITY APPLICATION

This application is a continuation of International Application No. PCT/US2018/055146, filed on Oct. 10, 2018, which claims priority to U.S. Provisional Application No. 62/571,950, filed on Oct. 13, 2017, the content of each of which is relied upon and incorporated herein by reference in its entirety.

### BACKGROUND

The disclosure relates generally to aversive materials and more particularly to aversive additives for cable jackets. Cables, such as power transmission cables, telephone cables, optical fiber cable, etc., are used to transmit electricity and/or data over distance. In order to do so, the cables have to be strung across land and/or buried in the ground between electricity/data sources and delivery points. Rodents have been known to chew on cables, which damages the cables and which can cause cable failure. Indeed, some estimates attribute approximately 17% of damage to aerial cables to squirrels alone. Other polymer articles are also subject to rodent chewing damage.

### SUMMARY

In one aspect, embodiments of a polymer composition are provided. The polymer composition includes at least one polymer, and a plurality of aversive additive particles dispersed in the at least one polymer. Each aversive additive particle is made up of an encapsulant, an aversive material contained within the encapsulant, and a protective material deposited around the encapsulant.

In another aspect, embodiments of a method of preparing a repellant polymer composition are provided. The method includes the steps of infusing an aversive material in an encapsulant, surrounding the encapsulant with a protective material to create an aversive additive, and compounding the aversive additive with a polymer. In particular, the compounding takes place at a temperature of at least 150° C.

In still another aspect, embodiments of a repellent cable are provided. The repellant cable includes at least one communication element and a polymeric jacket that surrounds the at least one communication element. The polymeric jacket is formed from a polymer matrix that includes an aversive additive dispersed therein. Further, the aversive additive includes a plurality of encapsulants into which an aversive material is infused and around which a protective material is deposited.

In yet another aspect, embodiments of an aversive additive are provided. The aversive additive is formed from an encapsulant into which an aversive material is infused. Further, a protective material surrounds the encapsulant. Advantageously, the aversive additive is thermally stable at temperatures greater than 150° C.

In a further aspect, embodiments of an article are provided. The article has a body formed from a polymer material. The body includes a polymer matrix and an aversive additive. The aversive additive is made of a plurality of encapsulants into each of which an aversive material is infused. Further, a protective material surrounds each of the encapsulants.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments.

FIG. 1 depicts a flow diagram of a method of preparing and deploying an aversive additive, according to an exemplary embodiment;

FIG. 2 is an FT-IR spectral comparison of untreated yeast cells and yeast cells infused with cinnamaldehyde, according to an exemplary embodiment;

FIG. 3 is an FT-IR spectral comparison of yeast cells treated only with calcium carbonate and cells treated with calcium carbonate after a polymer layer-by-layer pretreatment, according to an exemplary embodiment;

FIG. 4 is an SEM image of the aversive additive made according to an exemplary embodiment;

FIG. 5 is an SEM image of polished cross sections of stabilized cells made according to an exemplary embodiment;

FIG. 6 is an EDX spectrum of the elemental composition of the polished cross sections of FIG. 5;

FIG. 7 is an HPLC analysis of material extracted from the stabilized cells as compared to a cinnamaldehyde reference spectrum, according to an exemplary embodiment;

FIG. 8 is a DSC comparison of untreated yeast cells and of cells stabilized according to an exemplary embodiment;

FIG. 9 is an SEM image of the aversive additive extruded with medium density polyethylene, according to an exemplary embodiment;

FIG. 10 is an EDX spectrum of the elemental composition of the aversive additive dispersed in the medium density polyethylene as shown in FIG. 9; and

FIG. 11 depicts an optical fiber cable having a polymeric jacket in which the aversive additive was dispersed, according to an exemplary embodiment.

### DETAILED DESCRIPTION

Referring generally to the figures, various embodiments of an aversive additive for repelling rodents, birds, insects, monkeys, and other animals from structures made from or including polymers are provided. In many outdoor environments, animals tend to chew, gnaw, climb, or otherwise interact with man-made structures, such as electrical or telecommunication cables, which can cause these structures to prematurely fail, degrade, or be rendered unsuitable for their intended purpose. Aversive materials are used to repel animals before the animals have a chance to injure themselves or to cause damage to the structure. However, in certain circumstances, conventional aversive materials tend to bleed from the matrix in which they are deployed, experience environmental degradation, and/or require reapplication. In contrast, the aversive additives made according to embodiments of the present invention are encapsulated in a protective material, which allows the aversive additives to be compounded at high temperatures with a polymer, to be highly resistant to environmental degradation, to be dispersed evenly throughout the polymer, and to be released upon interaction with an animal. Applicant believes that no prior aversive additive has provided this combination of functionality, at least not at the performance levels provided by the aversive additive of the present disclosure.

To form the aversive additive in an exemplary embodiment, an aversive material is infused in an encapsulant, such as a yeast cell. Layer-by-layer polymer deposition is used to build up the charge density on the infused yeast cell such that a protective material can be deposited around and/or through the yeast cell. Applicant believes that a protective aversive package prepared by this process provides a high level of protection allowing the aversive material to survive both high temperature polymer manufacturing processes and to resist environmental degradation when deployed in a final polymer product.

After forming, the aversive additive can be deployed in a variety of ways to form a variety of products. Thus, also provided are a method of deploying the aversive additive as well as products including the aversive additive. Exemplary embodiments of the present invention, including the use of the aversive additive in a jacket of an electrical or telecommunications cable, are provided by way of illustration and not by way of limitation. A person of ordinary skill in the art, upon consideration of the present disclosure, may recognize that the aversive additive can be formed, applied, and/or used in different contexts beyond those discussed herein without departing from the spirit or scope of the present disclosure.

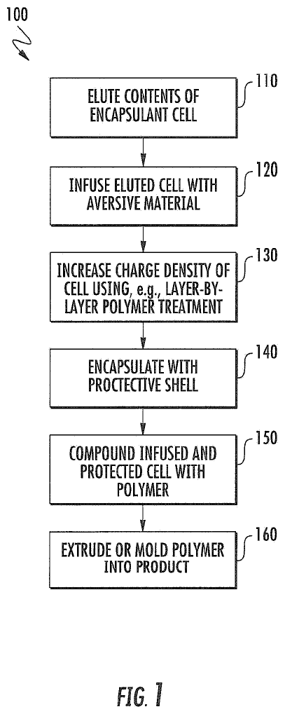

Referring to FIG. 1, a method 100 of preparing and deploying the aversive additive is provided. Generally, the method of preparing the aversive additive involves infusing an aversive material into an encapsulant, depositing a protective material around the encapsulant, and compounding the aversive additive with a polymer.

A variety of encapsulants are suitable for use in embodiments of the presently disclosed method. In some embodiments, the encapsulants discussed herein include a cell wall of an organism (e.g., a dead single-celled organism), and in some embodiments, the encapsulants are formed from a cell from which the cellular contents have been eluted. In specific embodiments the encapsulant is a yeast cell from which the cellular contents have been eluted. In specific embodiments, the encapsulant is a yeast cell, such as a yeast from the genus saccharomyces (e.g., cerevisiae, rouxii, or carlsbergensis) or candida (e.g., utilis, tropicalis, lipolytica, or flaveri). In embodiments, Saccharomyces cerevisiae, also known as “brewer's yeast,” having a cell diameter of 3 μm to 5 μm is used as the encapsulant. Further, the yeast cells can be provided in the live, dead, or dried state. Yeast cells of a variety of shapes are suitable for use as the encapsulant, including oval, sphere, lemon shape, pillar, ellipse, etc.

In other embodiments, the encapsulant is formed via an oil-in-water emulsion with encapsulating materials such as polyamides, melamines, phenolics, polyesters and mixtures thereof. Encapsulants made through the oil-in-water emulsion process can similarly have a variety of shapes, such as spherical, oval, lemon shape, pillar, ellipse, etc.

In embodiments, the encapsulant has a diameter of from 1 μm to 20 μm. As the shape of the encapsulant can vary, “diameter” as used herein is not meant to imply that the encapsulant is spherical or has a circular cross section. Instead, “diameter” is used to mean the maximum cross-sectional dimension of the encapsulant. In further embodiments, the encapsulant has a diameter of from 2 μm to 10 μm, and in still further embodiments, the encapsulant has a diameter of 3 μm to 5 μm.

In the described embodiment using brewer's yeast, the intracellular contents of the yeast cell are eluted in a first step 110. That is, the intracellular components of the yeast cell are removed to provide room for an aversive material to be encapsulated within the yeast cell wall. In particular, a significant portion of any or all of the nucleus, cytoplasm, ribosomes, vacuole, mitochondria, endoplasmic reticulum, glycogen, fat globules, etc. are removed while substantially maintaining the cell wall and/or portions of the plasma membrane. In embodiments, elution of the yeast cell removes from 10% to 80% by weight of the intracellular contents. In other embodiments, elution of the yeast cell removes 30% to 70% by weight of the intracellular contents.

Elution of the contents of the yeast cell can be accomplished in a variety of suitable ways. For example, in embodiments, the elution is accomplished by treating a yeast cell suspension at a suitable temperature (e.g., from 30° C. to 100° C.) and pH for a period of time (e.g., from 1 h to 24 h), and in other embodiments, the elution is accomplished by treating the yeast cell suspension with an enzyme preparation. In still other embodiments, the elution is accomplished by treating the yeast cell suspension with an elution promoting agent. Suitable elution promoting agents include polar organic solvents, such as lower alcohols; ethyl acetate and acetone; inorganic salts; sugars; papain; quaternary ammonium salts; and various germproof, anti-bacterial, and germicidal agents. In an embodiment, the yeast cells are suspended in water, and in such embodiments, the elution promoting agent or agents are added in an amount of four parts by weight or less to ten parts by weight of the yeast cell suspension. For example, in an exemplary embodiment, the elution step 110 was performed by suspending 10 g of yeast in 90 mL of distilled water. To this suspension, 10 mL of ethanol was added. The suspension was then stirred with a magnetic stirrer at 360 rpm for 22 h while held within the temperature range of from 40° C. to 45° C. The yeast cells were then centrifuged and washed with deionized water three times.

After the elution step 110, the yeast cells are infused with an aversive material in infusion step 120. As used herein, an aversive material is one that will repel an animal in the particular environment in which the aversive material is used. Generally, the aversive material will trigger a flavor, olfactory, or tactile response in the animal, repelling the animal from, e.g., chewing, pecking, or climbing on the structure containing the aversive material. Examples of suitable aversive materials include cinnamaldehyde, wintergreen oil, capsaicin, peppermint oil, bergamot oil, geranium oil, predator urine, eucalyptus, bitterants, pinene, lemon citrus oil, cedarwood oil, garlic oil, and any other aversive materials known in the art to produce an aversive reaction to an animal or animals in any or all environments.

In embodiments, the aversive material is hydrophobic. Optionally, in particular embodiments, the aversive material is dissolved in oil, such as soybean oil, almond oil, mineral oil, olive oil, etc. The list of oils is not exhaustive, and a person of ordinary skill in the art will recognize from the present disclosure that other oils can be utilized depending on the particular aversive material, encapsulant, application, etc. In embodiments, the ratio of aversive material to oil is from 10:1 to 1:10. In a particular embodiment, the aversive material is cinnamaldehyde dissolved in soybean oil at a ratio of one part by weight cinnamaldehyde to four parts by weight of soybean oil. In the experimental embodiment, red dye (Sudan III red) was added for the purposes of visually confirming the infusion of the aversive material in the yeast cells as will be discussed below.

In order to infuse the aversive material into the yeast cell encapsulant, the eluted yeast cells were dispersed in an aqueous surfactant solution. In particular, the aqueous surfactant solution was 50 mL of 0.5% octal phenol ethoxylate (Triton X-100, Dow Chemical Company). To the yeast cell dispersion, 10 mL of the aversive material was added. This mixture was stirred with a magnetic stirrer at 360 rpm and at a temperature of 40° C. for 2 h. The cells were centrifuged and washed three times. The yeast cells were pink in color (on account of the red dye), thereby confirming the infusion of the aversive material into the cells.

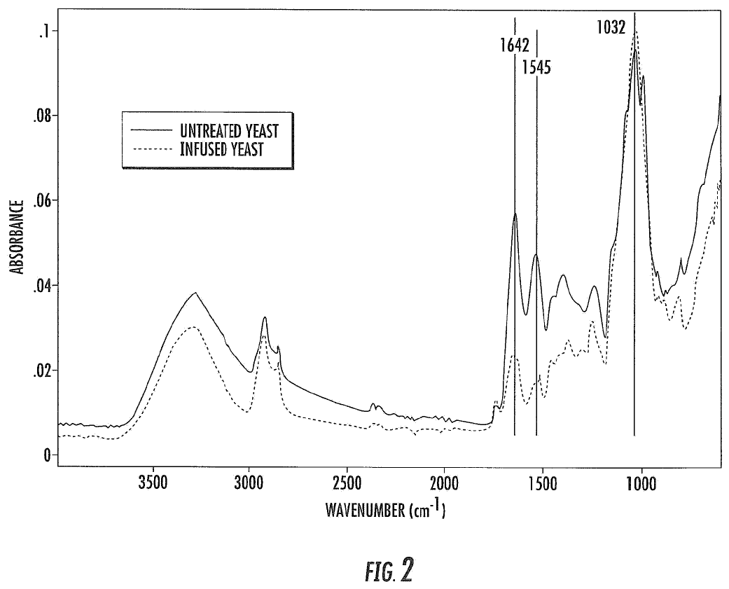

For stabilization and protection of the encapsulated material (e.g., from high temperatures during polymer processing, from the environment when deployed, etc.), a protective material is deposited around the infused cells. However, after the elution and infusion, the yeast cells have low charge density. Indeed, FIG. 2 provides an FT-IR spectral comparison of untreated yeast cells (i.e., not eluted or infused) and yeast cells after infusion with oil. A decrease in absorptions related to amides (at wavenumbers 1642 cm⁻¹ and 1545 cm⁻¹) as compared to the carbohydrate band (at wavenumber 1032 cm⁻¹) after infusion is evident. It is surmised that the decrease in absorption related to amides signifies a breakdown in surface proteins and, consequently, results in the decrease in surface charge.

Thus, after the infusion step 120, the charge density of the yeast cells is built back up. In a particular embodiment, the charge density of the yeast cells is built back up through layer-by-layer polymer deposition in step 130. Layer-by-layer (LbL) deposition involves alternatingly applying oppositely charged materials to build up a charged film on a surface. In embodiments, suitable polymers for the positively charged component include polyethyleneimine, chitosan, polyallylamine, and/or polydiallyldimethyl. In such embodiments, suitable polymers for the negatively charged component include poly(acrylic acid), hyaluronic acid, sodium alginate, and/or polystyrene sulfonate. The list of suitable positively and negatively charged polymers is not exhaustive, and a person of ordinary skill in the art, upon consideration of the present disclosure, may recognize other positively and negatively charged polymers are suitable for a particular application.

In another embodiment, which may be suitable in particular for the oil-in-water emulsion formation of encapsulants, the charge density is built back up using pH adjustment. That is, the pH of the liquid in which the polymer encapsulants are suspended can be adjusted to form ions on the polymer by, e.g., adding or removing hydrogen atoms.

In an exemplary embodiment, layer-by-layer deposition was performed using positively charged polydiallyldimethyl ammonium chloride (PDADMAC) and negatively charged poly(acrylic) acid (PAA) sodium salt. In particular, five grams of infused cells were dispersed in 1 L of 0.5% solution of PDADMAC in 0.12 M sodium chloride, and the infused cells were stirred in the solution at 360 rpm for 20 min at room temperature. Thereafter, the infused cells were centrifuged and washed three times in 0.12 M sodium chloride. Next, the infused cells were re-dispersed in a 0.5% solution of PAA in 0.12 M sodium chloride, and the infused cells were stirred at 360 rpm for 20 min at room temperature. Again, the infused cells were centrifuged and washed three times in 0.12 M sodium chloride. The infused cells underwent these alternating positive (PDADMAC) and negative (PAA) treatments from two to four times to produce a total of four or eight polymer layers. In other embodiments, more or fewer polymer treatments could be applied to achieve a desired charge density, e.g., to achieve a particular charge density required for a particular protective material. Advantageously, using layer-by-layer polymer treatment, the treatment can be tailored to leave either a negative or a positive charge on the surface of the encapsulants, which allows for more variety in the types of subsequent treatment.

After the step 130 of building up charge density, the protective material can be applied in step 140. In embodiments, the protective material is an inorganic mineral. In embodiment, the protective material includes one or more of inorganic oxides, silicides, silica, carbides, carbonates, phosphates, sulfates, nitrides, etc. Exemplary protective materials include calcium carbonate, calcium phosphate, silica, iron oxide, graphene, and the like, and/or combinations thereof. The protective material is configured to thermally stabilize the encapsulant at typical polymer processing temperatures (e.g., up to 150° C., up to 250° C., up to 350° C., or even up to 400° C.) and provide mechanical stability such that the aversive additive is able to be compounded and extruded with a polymer. In other embodiments, the protective material can be selected to provide other forms of stability in particular environments, such stability against acidic environments, UV exposure, etc.

Regarding mechanical stability, in particular, the protective material needs to allow the release of the aversive material upon interaction with an animal while also being able to withstand typical stresses during processing and handling. For this purpose, in an embodiment, the protective material is configured to withstand pressures of at least 1000 psi. In another embodiment, the protective material will break, rupture, or otherwise fail at a pressure of no more than 10,000 psi. In certain embodiments, the protective material will withstand pressures of from 3000 psi to 6000 psi. Thus, for example, the protective material will collapse when bitten by a rodent, releasing the aversive material, while not being released by forces during handling, installation, etc. of the polymer composition into which the aversive additive is incorporated.

In one embodiment, the protective material is calcium carbonate. Advantageously, calcium carbonate is relatively inert, which helps to avoid undesirable interactions with the polymer during the compounding process described below. To deposit the calcium carbonate on the encapsulant, the eluted, infused, and charged cells were dispersed in 1 L calcium chloride and stirred for 20 min at 360 rpm at room temperature. One liter of sodium carbonate was added to the dispersion of cells. Immediately, the protective material formed around the infused and polymer treated cells to complete the formation of the aversive additive. Deposition of the protective material was evident from visibility of a white precipitate in the dispersion. To ensure complete deposition of the protective material, the solution was stirred for 5 min before being centrifuged and washed three times with deionized water. The aversive additive was dried by lyophilization for 48 h.

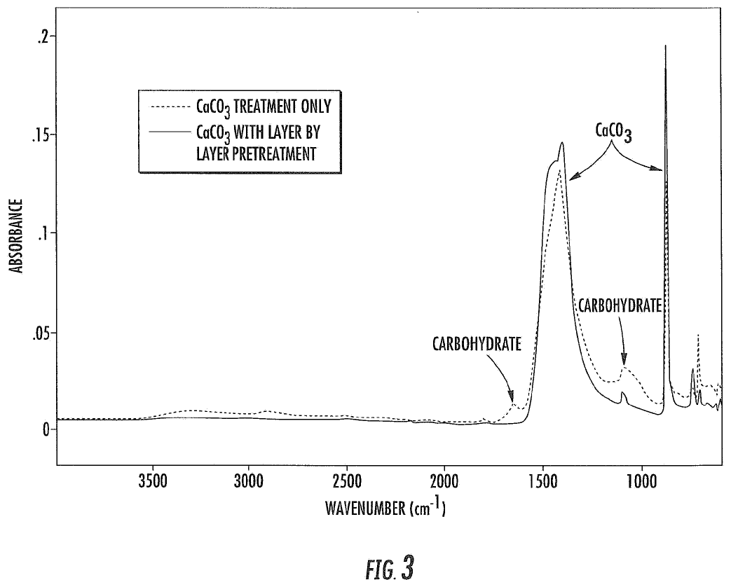

The aversive additive were then subjected to a variety of characterization techniques, including attenuated total reflectance Fourier-transform infrared spectroscopy (FT-IR), scanning electron microscopy (SEM) and energy dispersive spectroscopy (EDX), high performance liquid chromatography (HPLC), and differential scanning calorimetry (DSC). The FT-IR spectrum from the aversive additive is shown in FIG. 3. In particular, FT-IR spectra are shown for yeast cells that were treated only with calcium carbonate without prior layer-by-layer polymer treatment and for yeast cells treated with the polymer layer-by-layer treatment prior to calcium carbonate deposition. As can be seen in a comparison between the two FT-IR spectra, carbohydrate peaks can be seen in the spectrum of the yeast cells without the layer-by-layer polymer deposition, indicating incomplete coverage of the yeast cell walls without the polymer pretreatment. Thus, providing a buildup of charge density on the yeast cell through layer-by-layer polymer treatment allows for more complete and robust coverage by the protective material.

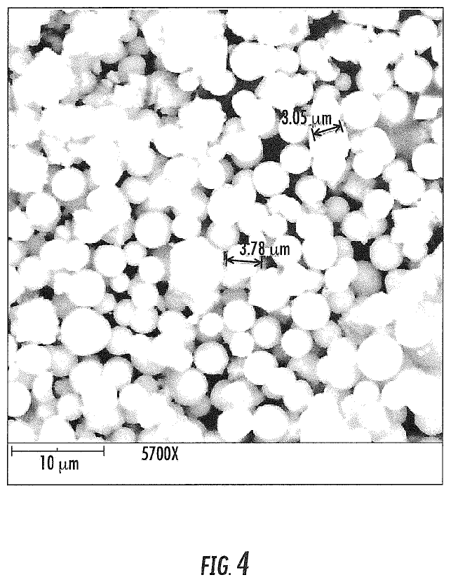

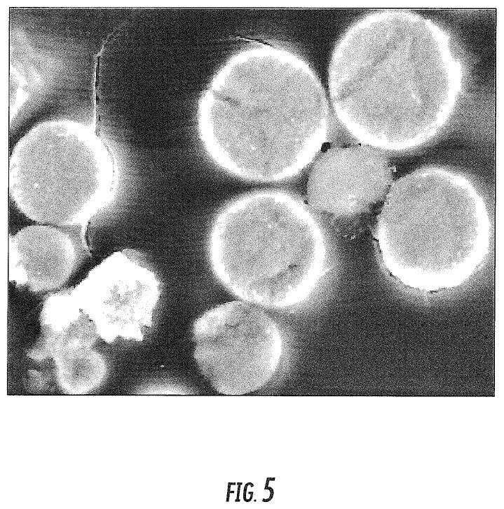

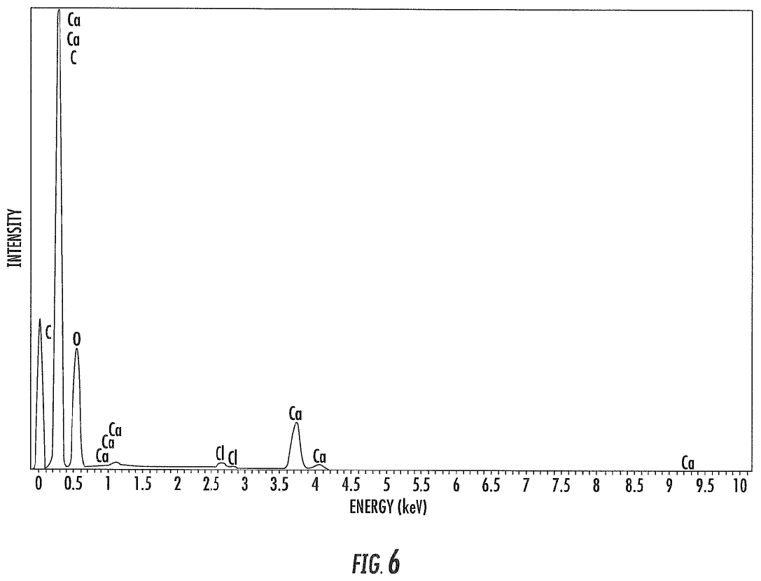

FIG. 4 provides an SEM image of the aversive additive. As can be seen, the aversive additive particles are generally spherical in shape and relatively uniform in size. In particular, the aversive additive particles have a diameter of from 3 μm to 6 μm. As mentioned above, the starting yeast from which the aversive additive was made had an initial diameter of 3 μm to 5 μm, and thus, the aversive additive particles do not increase much in diameter as a result of the layer-by-layer and protective material treatments. FIG. 5 shows another SEM image of a cross-section of the aversive additive. EDX analysis was performed on this cross-section, and the resulting spectrum is shown in FIG. 6. As can be seen there, calcium is present throughout the aversive additive particles so as to create a somewhat solid particle as opposed to a layered core/shell morphology. The infusion of calcium throughout the particle is believed to enhance the thermal and environmental stability of the aversive additive particles. Thus, in embodiments, the protective material forms, in a sense, a supporting protective matrix for the encapsulant. However, in other embodiments, the protective material only deposits outside of the encapsulant to form a protective layer or shell.

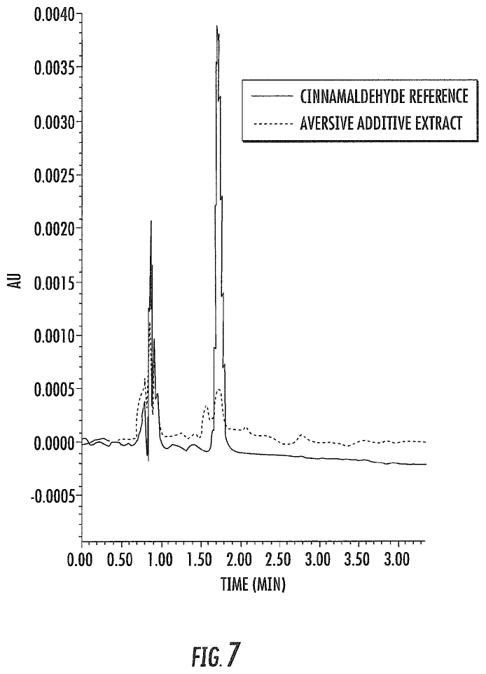

In order to verify that the aversive additive particles still contained the aversive material after the layer-by-layer polymer treatment and calcium carbonate deposition, material extracted from the aversive additive was subjected to HPLC analysis, and the resulting spectrum is shown in FIG. 7. The spectrum of the aversive additive extract was overlaid on a cinnamaldehyde reference spectrum, and cinnamaldehyde characteristic peaks match, indicating that the aversive additive still contains cinnamaldehyde.

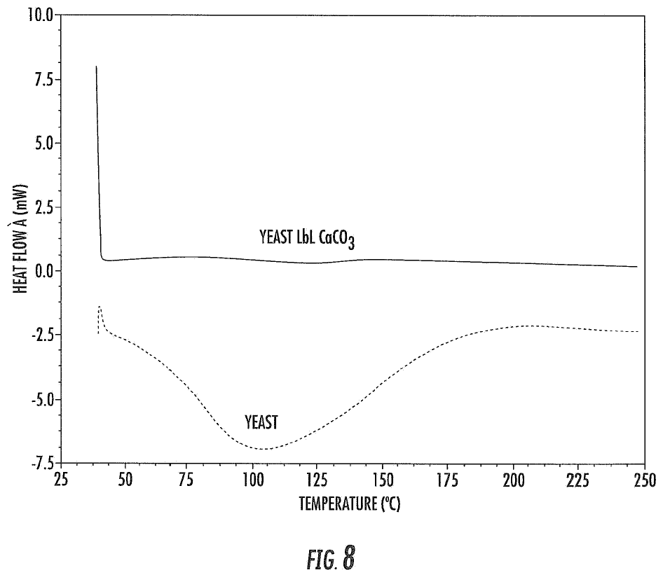

Additionally, using DSC, the thermal stability of the aversive additive was measured up to 250° C. By “thermal stability” or “thermally stable,” it is meant that the aversive additive does not experience melting, burning, combustion, or boiling over the stated temperature range. In embodiments, “thermal stability” or “thermally stable” means that the aversive additive has a substantially flat DSC curve over a stated temperature range as shown in FIG. 8. More particularly, in embodiments, “thermal stability” or “thermally stable” means that, after exposing the aversive additive to typical polymer processing temperatures (e.g., 150° C. to 400° C.), the aversive material is still present in the aversive additive in an amount sufficient to produce an aversive reaction from an animal. A comparison of the thermal stability of the aversive additive to a yeast cell is shown in FIG. 8. As can be seen, the yeast cell exhibits a melt temperature of around 100° C., whereas the aversive additive does not exhibit a melt temperature up to at least 250° C. This level of thermal stability allows the aversive additive to be compounded and extruded at typical polymer processing temperatures. In other embodiments, deposition of the protective material is believed to raise melt temperature of aversive infused yeast cells to 400° C. Absent the stabilization provided by the protective material, the yeast cell would otherwise be degraded at the temperatures typical to polymer processing.

After infusing and stabilizing the yeast cells, the aversive additive was then compounded with a polymer in step 150. The aversive additive can be compounded with a variety of suitable polymers, including thermoplastic polymers, thermoset polymers, elastomers, and thermoplastic elastomers. Exemplary polymers include ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the polymers listed above. In another embodiment, exemplary polymers include halogenated thermoplastics (such as polyvinyl chloride); polyamide 6, 6/6, 11, or 12 resins, thermoplastic polyurethane; or a crosslinked polyethylene. In the experimental embodiment, the aversive additive was compounded with medium density polyethylene (MDPE).

In an embodiment, the aversive additive is mixed with other optional polymer additives prior to or during compounding. Typical polymer additives include pigments, stabilizers, fungicides, and fillers, such as zeolite, clay, talc, etc. In embodiments, the aversive additive comprises between 1% and 30% by weight of the polymer composition. In certain embodiments, the aversive additive other polymer additives together comprise from 2% to 50% by weight of the polymer composition.

In the exemplary embodiment, the aversive additive was combined with zeolite and compounded with the MDPE such that the MDPE made up 70% by weight of the polymer composition. The ratio of aversive additive to zeolite was 1:1.4. Samples containing the aversive additive, zeolite, and MDPE were extruded in step 160 using a twin screw extruder (34 mm Twin Screw Extruder, available from Leistritz Extrusionstechnik GmbH) according to the processing conditions set forth in Table 1, below.

TABLE 1
Compounding Conditions for Polymer
Composition with Aversive Additive

| | |
|---|---|
| Screw Speed (RPM) | 100 |
| Single Feeder (kg/hr) | 0.86 |
| Twin Screw Feeder (g/min) | 6.5 |
| Zone 1 (° C.) | 100 |
| Zone 2 (° C.) | 160 |
| Zone 3 (° C.) | 180 |
| Zone 4 (° C.) | 180 |
| Zone 5 (° C.) | 180 |
| Zone 6 (° C.) | 180 |
| Zone 7 (° C.) | 180 |
| Zone 8 (° C.) | 190 |
| Zone 9 (° C.) | 190 |
| Zone 10 (° C.) | 190 |
| Die Temp (° C.) | 190 |
| Torque (amps) | 11 |

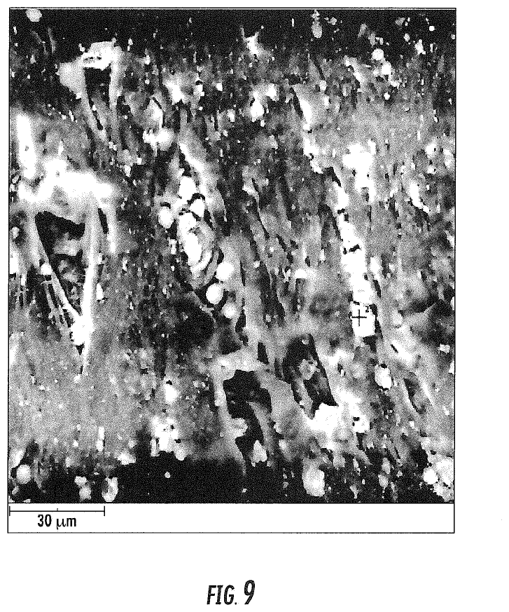

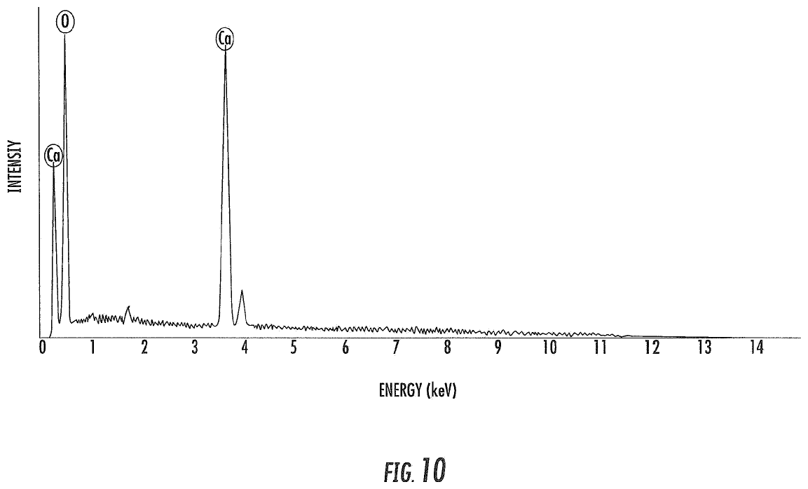

FIG. 9 is an SEM image of a sample of the polymer composition including the aversive additive, zeolite, and MDPE following extrusion. As can be seen in FIG. 9, unbroken aversive particles (white spherical particles) are present in the polymer matrix after compounding and extrusion. As can also be seen, the aversive additive is well-distributed within the MDPE matrix. The irregularly shaped particles seen in FIG. 9 are the zeolite filler material. An EDX analysis of the sample can be seen in FIG. 10. Calcium and oxygen peaks can be seen, indicating the presence of the protective calcium carbonate layer around the aversive additive particles.

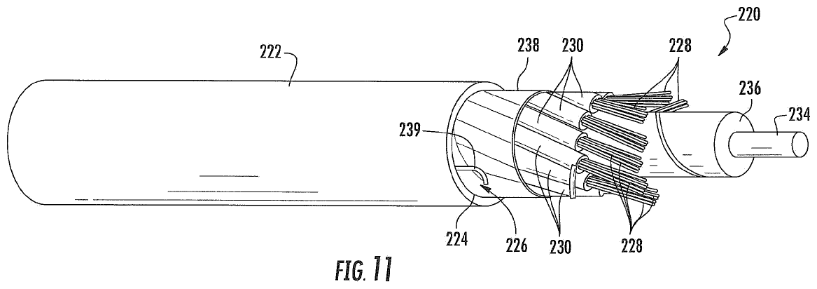

The aversive additive as described herein can be extruded or molded with or otherwise dispersed in a polymer usable in a variety of applications. In some embodiments, the aversive additive described herein is added to a thermoplastic polymer material that is then melted and shaped through extrusion, injection molding, compression molding or any other suitable process to form a polymeric article. In other embodiments, the aversive additive described herein is added to a polymer precursor mixture that is then cured or crosslinked, e.g., via UV, heating, etc., to form a polymeric article. In embodiments, the aversive additive is in extruded jacketing for cables, such as electrical communication cables, optical communication cables, etc. In a particular embodiment as shown in FIG. 11, the aversive additive is shown as part of an optical fiber cable 220. Cable 220 includes a cable body, shown as polymeric jacket 222, having an inner surface 224 that defines a channel, shown as central bore 226. Pluralities of communication elements, shown as optical fibers 228, are located within bore 226. The cable 220 includes a plurality of core elements located within central bore 226. A first type of core element is an optical transmission core element, and these core elements include bundles of optical fibers 228 that are located within tubes, shown as buffer tubes 230. Buffer tubes 230 are arranged around a central support, shown as central strength member 234. Central strength member 234 includes an outer coating layer 236. A barrier material, such as water barrier 238, is located around the wrapped buffer tubes 230. An easy access structure, shown as rip cord 239, may be located inside polymeric jacket 222 to facilitate access to buffer tubes 230.

In one embodiment, the aversive additive is incorporated into the polymeric jacket 222 of fiber optic cable 220. In another embodiment, the aversive additive is incorporated into the buffer tubes 230 surrounding the bundles of optical fibers 228. In a further embodiment, the aversive additive is incorporated into the water barrier 238. By extruding a polymer containing the aversive additive around the cable and cable components, the cable 220 is less susceptible to damage from rodents, birds, insects, monkeys, and other animals, and the aversive additive will remain stable in the cable 220 much longer than conventional aversive additives such that reapplication is not required. Moreover, such cables do not need the extensive metal armors that are frequently required in conventional cables to protect against animal-related damage. Dispensing with these metal armors reduces the weight and expensive of the cable.

In some embodiments, optical fibers 228 having primary and secondary polymer coating layers surrounding a glass core. In specific embodiments, the aversive material described herein is included in at least one of the primary or secondary polymer coating layer. In some embodiments, multiple optical fibers 228 may be supported in a ribbon matrix, and the aversive material described herein is included in the ribbon matrix. In specific embodiments, the primary coating, secondary coating and/or ribbon matrix is formed from a UV curable material (e.g., an acrylate material) to which the aversive material described herein is added prior to UV curing or crosslinking.

In other embodiments, the aversive additive is included in plastic or polymer articles in applications related to agriculture; aircrafts; automobiles; fluid transportation; residential, commercial, industrial, and architectural structures; paints; and storage containers. In an agricultural setting, rodents are known to chew through irrigation lines, such as tubing for drip irrigation. According to an embodiment of the present invention, the aversive additive is compounded with the polymer used to make the irrigation line. According to another embodiment, the aversive additive is compounded with a polymer used to form a jacket around the irrigation line.

Further, in an agricultural setting, food stores are especially attractive to rodents and other animals. Therefore, in embodiments, the aversive additive is dispersed in polymers molded into boxes, bags, or the like for food storage applications. Similarly, in many agricultural settings, plastics are used to form fences, pens, stalls, cages, etc. that are susceptible to chewing/damage by livestock animals contained in such structures. Therefore, in embodiments, the aversive additive is dispersed in polymers molded into fences, pens, stalls, cages, etc.

In aircrafts, rodents can pose a threat to interior electrical, fuel, and sealing systems because rodents chew on electrical wires, fuel lines, and seals. Thus, in embodiments, the aversive additive is incorporated in polymers used in electrical wires, electrical encasements, fuel lines, seals, gaskets, belts, etc. Further, systems external to the aircraft are susceptible to failure as a result of damage inflicted by rodents. For example, aircraft arrestor systems frequently include polymer components as jacket materials, cables, etc. In embodiments, the aversive additive is incorporated into any or all of the polymers used in the arrestor system. Similar to risks posed to aircrafts, automobiles include many electrical, fuel, sealing, structural, and mechanical systems that employ polymer components. Thus, in embodiments, the aversive additive is incorporated in polymers for electrical wires, electrical encasements, fuel lines, seals, gaskets, belts, body panels, bumpers, lights, vehicle trim, etc.

In the fluid transportation setting, polymer fluid lines, tubing, hoses, and the like are used in certain applications to carry fuel, water, hydraulic fluid, air, gases, chemicals, etc. in residential, commercial, and industrial settings. These lines are susceptible to damage from rodents, and a failure of such fluid transportation lines as a result of damage from rodents can be expensive to repair, cause significant downtime, and, in certain circumstances, create dangerous leaks of corrosive, combustible, polluting, or poisonous fluid. Accordingly, in embodiments, the aversive additive is dispersed in the polymer used to make such fluid lines, tubing, hoses, etc.

Many residential, commercial, industrial, and architectural structures are susceptible to damage from rodents, birds, and other animals. For example, rodents are known to chew through weather stripping and siding elements, which damages the structure, creates unwanted exposure to weather, and degrades the aesthetic appeal of the structure. Further, birds are known to peck on siding, to roost on surfaces, and to build nests on such structures, which tends to damage the structure and expose the surfaces to bird droppings. Accordingly, in embodiments, the aversive additive is included in weather stripping material, vinyl siding, and other structural elements. Further, in embodiments, the aversive additive is suspended in a paint that is applied to such residential, commercial, industrial, and architectural structures.

In still another embodiment, the aversive additive is used in storage containers, especially outdoor storage containers. Polymers are frequently used to form lightweight, portable, and relatively inexpensive storage containers. In outdoor settings, such containers are exposed to a variety of rodents, birds, and other animals that may attempt to make nests within the storage containers and that may attempt to gnaw or peck their way into the container. Accordingly, in embodiments, the aversive additive is incorporated into the polymer that is formed into the storage container or a component of the storage container.

The embodiments of applications in which the aversive additive can be used are provided for the purposes of illustration only and not by way of limitation. Indeed, the aversive additive can be incorporated in many applications using a polymer as a coating and/or as a component.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A polymer composition, comprising:
at least one polymer; and
a plurality of aversive additive particles dispersed in the at least one polymer, each aversive additive particle comprising:
an encapsulant;
an aversive material contained within the encapsulant; and
a protective material deposited around the encapsulant.

2. The polymer composition of claim 1, wherein the encapsulant comprises a cell wall.

3. The polymer composition of claim 2, wherein the encapsulant comprises the cell wall of a single-celled organism.

4. The polymer composition of claim 3, wherein the single-celled organism is a yeast cell of the genus saccharomyces or candida.

5. The polymer composition of claim 4, wherein the encapsulant comprises Saccharomyces cerevisiae.

6. The polymer composition of claim 1, wherein each aversive additive particle further comprises at least one polymer layer surrounding at least a portion of the encapsulant.

7. The polymer composition of claim 6, wherein the at least one polymer layer comprises at least four polymer layers formed via alternating deposition of a positively charged polymer and a negatively charged polymer.

8. The polymer composition of claim 7, wherein the positively charged polymer includes at least one of polyethyleneimine, chitosan, polyallylamine, or polydiallyldimethyl, and wherein the negatively charged polymer includes at least one of poly(acrylic acid), hyaluronic acid, sodium alginate, or polystyrene sulfonate.

9. The polymer composition of claim 1, wherein the aversive material includes at least one of cinnamaldehyde, wintergreen oil, capsaicin, peppermint oil, bergamot oil, geranium oil, predator urine, eucalyptus, bitterants, pinene, lemon citrus oil, cedarwood oil, or garlic oil.

10. The polymer composition of claim 1, wherein the aversive material is dissolved in an oil.

11. The polymer composition of claim 1, wherein the protective material is formed from at least one of a carbonate, a phosphate, silica, an inorganic oxide, or graphene.

12. The polymer composition of claim 1, wherein the aversive additive particles are thermally stable at temperatures up to 150° C.

13. The polymer composition of claim 1, comprising from 1% to 30% by weight of the aversive additive.

14. The polymer composition of claim 1, wherein the at least one polymer includes a thermoplastic polymer, a thermoset, a thermoplastic elastomer, or an elastomer.

15. The polymer composition of claim 1, wherein the encapsulant is formed from an oil-in-water emulsion of an encapsulating material, the encapsulating material including at least one of a polyamide, a melamine, a phenolic, or a polyester.

16. A method of preparing a repellant polymer composition, comprising the steps of:
infusing an aversive material in an encapsulant;
surrounding the encapsulant with a protective material to create an aversive additive;
compounding the aversive additive with a polymer at a temperature of at least 150° C. to form the repellent polymer composition.

17. The method of claim 16, wherein the encapsulant is a yeast cell, and the method further comprises the step of eluting the contents of the yeast cell prior to encapsulating the aversive material in the encapsulant.

18. The method of claim 16, further comprising the step of selecting the aversive material to be at least one of cinnamaldehyde, wintergreen oil, capsaicin, peppermint oil, bergamot oil, geranium oil, predator urine, eucalyptus, bitterants, pinene, lemon citrus oil, cedarwood oil, or garlic oil.

19. The method of claim 16, further comprising the step of treating the encapsulant so as to build up the charge density on the surface of the encapsulant after the infusing step and prior to the surrounding step.

20. The method of claim 19, wherein the treating step comprises applying alternating layers of a positively charged polymer and a negatively charged polymer.

21. The method of claim 20, further comprising the step of selecting the positively charged polymer to include at least one of polyethyleneimine, chitosan, polyallylamine, or polydiallyldimethyl and selecting the negatively charged polymer to include at least one of poly(acrylic acid), hyaluronic acid, sodium alginate, or polystyrene sulfonate.

22. A repellent cable, comprising:
at least one communication element;
a polymeric jacket that surrounds the at least one communication element;
wherein the polymeric jacket comprises:
a polymer matrix; and
an aversive additive dispersed in the polymer matrix, the aversive additive comprising:
a plurality of encapsulants;
an aversive material infused in each of the encapsulants; and
a protective material surrounding each of the encapsulants.

23. The repellent cable of claim 22, wherein the at least one communication element is at least one optical fiber.
